(19) United States
(12) Patent Application Publication
(10) Pub. No.: US 2023/0256941 A1
(43) Pub. Date: Aug. 17, 2023

(54) Roof module comprising a cleaning feature

(71) Applicant: Webasto SE, Stockdorf (DE)

(72) Inventors: Magnus SVIBERG, Stockdorf (DE); Maximilian EHRMANN, Stockdorf (DE); Cèdric LANGLAIS, Stockdorf (DE); Michael HUELSEN, Stockdorf (DE)

(21) Appl. No.: 18/166,751

(22) Filed: Feb. 9, 2023

(30) Foreign Application Priority Data
Feb. 17, 2022 (DE) 10 2022 103 831.9

(51) Int. Cl. B60S 1/52; B60S 1/48; B62D 25/06

(52) U.S. Cl. CPC B60S 1/52; B60S 1/487; B62D 25/06

(57) ABSTRACT

A roof module for forming a vehicle roof on a motor vehicle, the roof module having a panel component, which at least partially forms a roof skin of the vehicle roof, the roof skin serving as an outer sealing surface of the roof module, at least one electrical and/or electronic and/or electromagnetic component, in particular an environment sensor and/or a light feature, configured to send and/or receive electromagnetic signals through a see-through area, and at least one cleaning feature having at least one cleaning nozzle configured to spray a cleaning fluid by means of which the see-through area is cleanable. The at least one component is in heat-transferring connection with the cleaning feature in such a manner that waste heat of the at least one component can be transferred to the cleaning fluid and/or the at least one cleaning nozzle.

### CROSS-REFERENCE TO RELATED APPLICATION

This application claims priority from German Patent Application Number DE 10 2022 103 831.9, filed Feb. 17, 2022, which is hereby incorporated herein by reference in its entirety for all purposes.

### FIELD

The invention relates to a roof module, in particular a roof sensor module, according to the preamble of claim 1 for forming a vehicle roof on a motor vehicle.

### BACKGROUND

Generic roof modules are widely used in vehicle manufacturing since these roof modules can be prefabricated as separate functional modules and can be delivered to the assembly line when assembling the vehicle. The roof module at least partially forms a roof skin of the vehicle roof at its outer surface, the roof skin preventing moisture and air flows from entering the vehicle interior. The roof skin is composed of one or more panel components, which can be made of a stable material, such as painted metal or painted or died-through plastic. The roof module can be a part of a fixed vehicle roof or a part of an openable roof sub-assembly.

Furthermore, the development in vehicle manufacturing is increasingly focusing on autonomously and semi-autonomously driving motor vehicles. In order to enable the vehicle controller to control the motor vehicle autonomously or semi-autonomously, a plurality of electrical and/or electronic and/or electromagnetic components, in particular environment sensors (e.g., lidar sensors, radar sensors, (multi-)cameras, etc. including other (electrical) components), are employed, which are integrated in the roof module, for example, and which detect the environment surrounding the motor vehicle and determine, for example, a current traffic situation from the detected environment data. Roof modules which are equipped with a plurality of environment sensors are also known as roof sensor modules (RSM). For this purpose, the known environment sensors send and/or receive suitable electromagnetic signals, such as laser beams or radar beams, allowing a data model of the vehicle environment to be generated by signal evaluation and to be used for controlling the vehicle.

The environment sensors and other electrical and/or electronic and/or electromagnetic components for monitoring and/or detecting the vehicle environment are typically mounted on the vehicle roof since the vehicle roof is typically the highest point of a vehicle, from where the vehicle environment is easily visible. The components and/or environment sensors are typically placed on top of the panel component of the roof module, which forms the roof skin, as attachments; alternatively, they can also be disposed in an opening of the roof module and be adjustable between a retracted position and a deployed position.

When the environment sensor is in use, ambient conditions (e.g., weather) pose the risk that a ((partially) transparent) see-through area, through which the environment sensor and/or the component detects the vehicle environment, accumulates dirt, thus becoming partially opaque. For cleaning these areas, the use of cleaning features comprising at least one cleaning nozzle is known, by means of which the see-through area can be cleaned. Similar to spray nozzles of a windshield wiper system, the known cleaning nozzles are typically disposed statically in an area of the roof module or the panel component that is located in front of the environment sensor when viewed in the direction of an optical axis of the environment sensor. An adjustable, in particular retractable and deployable, configuration of cleaning nozzles, e.g., by means of hydraulic water pressure, is known as well. In the state of the art, a cleaning fluid used is supplied to the cleaning nozzle via at least one hose line or supply line; the fluid flow can be controlled by means of one or more than one valve, for example. For transport, the cleaning fluid is preferably pressurized by means of a pump (in the case of liquid cleaning fluids) or a compressor (in the case of gaseous cleaning fluids).

Moreover, it is known for at least one check valve to be integrated in the cleaning nozzle or to be disposed a short distance upstream of the cleaning nozzle in order to prevent the cleaning fluid from flowing backward. One disadvantage of this design is that fluid residue often remains at the at least one cleaning nozzle and/or at the at least one check valve and/or in the at least one supply line after cleaning. Under cold ambient conditions, it can happen that parts of the cleaning feature freeze because of this remaining fluid residue and are therefore at least temporarily inoperable. The cleaning nozzle, in particular its nozzle head, is particularly susceptible to this kind of failure since it is particularly sensitive to freezing because of its design, which is configured for finely disperse atomization of the cleaning fluid. This effect is additionally amplified by the fact that the cleaning fluid is pressurized between the check valve and the nozzle head. Hence, the problems mentioned are to be avoided.

As a solution approach, it is known from the state of the art for the at least one cleaning nozzle to be heated by means of an electrical heating device in order to prevent the cleaning fluid from freezing under cold ambient conditions. Heating the cleaning fluid is advantageous under moderate ambient conditions, as well, since the see-through area can be cleaned more efficiently with the heated cleaning fluid. However, this requires the provision of additional electrical energy. Moreover, cables have to lead to the heating device and need to be insulated from the cleaning feature in a moisture-proof manner. This leads to more assembly work and requires more material, which is accompanied by higher production costs. Thus, the known solution approaches need further optimization.

### SUMMARY

Hence, an object of the invention is to propose a roof module that avoids the disadvantages of the state of the art described above and in particular allows economically efficient heating of a cleaning fluid.

This object is attained by a roof module according to the teaching of claim 1. Furthermore, the object is attained by a motor vehicle having at least one roof module according to the invention.

Advantageous embodiments of the invention are the subject matter of the dependent claims. Moreover, any and all combinations of at least two features disclosed in the description, the claims, and/or the figures fall within the scope of the invention. Naturally, the explanations given in connection with the roof module equivalently relate to the motor vehicle according to the invention without being mentioned separately in its context. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

The roof module according to the invention, in particular a roof sensor module, for forming a vehicle roof on a motor vehicle comprises a panel component, which at least partially forms a roof skin of the vehicle roof, the roof skin serving as an outer sealing surface of the roof module. Furthermore, the roof module comprises at least one electrical and/or electronic and/or electromagnetic component, in particular an environment sensor and/or a light feature, which can send and/or receive electromagnetic signals through a see-through area. The roof module comprises at least one cleaning feature having at least one cleaning nozzle configured to spray a cleaning fluid which can clean the see-through area. The roof module is characterized in that the at least one component is in heat-transferring connection with the cleaning feature in such a manner that waste heat of the at least one component can be, in particular is, transferred to the cleaning fluid and/or the at least one cleaning nozzle and/or a cleaning fluid tank. Preferably, the see-through area is made of a material that is transparent to, i.e., penetrable by, the electromagnetic signals and/or waves sent and/or received by the at least one component. For example, the see-through area can be made of plastic or glass. The see-through area is preferably a window or a lens through which the at least one component looks in order to detect a vehicle environment and/or send signals into the vehicle environment.

According to the invention, it is possible to use the waste heat of the at least one component for heating the cleaning fluid instead of heating the cleaning fluid and/or a cleaning fluid tank and/or the cleaning nozzle by means of a usually electrical heating device like in the state of the art. This saves components and in particular electrical energy. Additionally, installation space previously needed for the heating device is now freely available, which means that a passenger compartment and/or a roof area of the vehicle and/or a panoramic roof can be made larger, for example. This manner of waste heat exploitation has the advantage that it simultaneously cools the at least one component since its waste heat can be discharged effectively. Additionally, heating the cleaning fluid amplifies a cleaning effect, which increases a reliability of the at least one component. Particularly preferably, the cleaning fluid can be heated in such a manner according to the invention that the see-through area can be deiced. Thus, additional deicing of the see-through area is unnecessary since the deicing function is provided in a simple manner using synergistic effects. Overall, the configuration of the roof module according to the invention reduces the production costs. Moreover, the consumption of electrical energy is minimized. Also, components can be dispensed with, which enables a more compact architecture. Overall, the installation and the maintenance of the roof module are thus simplified according to the invention.

So, according to the invention, the at least one component is in heat-conducting or heat-transferring connection with the cleaning feature, in particular with at least part of the cleaning feature, with the result that the waste heat of the component can be transferred to the cleaning feature and/or the cleaning fluid via this connection. This heat-transferring connection can be technically configured in any manner as long as the waste heat can be reliably discharged from the at least one component. Particularly preferably, the heat-transferring and/or heat-conducting connection is configured in such a manner that heat losses during the transfer can be prevented or at least minimized, for example, by providing suitable insulation. This is advantageous since it means that more waste heat is available for heating the cleaning fluid.

The roof module according to the invention can form a structural unit in which features for autonomous or semi-autonomous driving assisted by driver assistance systems are integrated and which can be placed on a vehicle carcass as a structural unit by a vehicle manufacturer. Furthermore, the roof module according to the invention can be a purely fixed roof or a roof including a roof opening system. Moreover, the roof module can be configured for use with a passenger car or a utility vehicle. The roof module can preferably be provided as a structural unit in the form of a roof sensor module (RSM), in which the environment sensors are provided, so as to be inserted into a roof frame of a vehicle body as a suppliable structural unit.

The environment sensor according to the invention can basically be configured in various ways and can in particular comprise a lidar sensor, a radar sensor, an optical sensor, such as a camera, and/or the like. Lidar sensors operate in a wavelength range of 905 nm or about 1550 nm, for example. The material of the roof skin in the see-through area should be transparent to the wavelength range used by the environment sensor and should hence be selected as a function of the wavelength(s) used by the environment sensor.

In a preferred embodiment, the roof module comprises a thermal management feature configured to control the temperature of, in particular cool, the at least one component. The thermal management feature comprises at least one heat exchanger which is in in heat-conducting connection with the at least one component and configured to transfer the introduced waste heat of the at least one component to the cleaning fluid. For example, the heat exchanger can be a flow-type heat exchanger, which preferably comprises two passages and/or flow channels, which in particular have opposite flow directions. For example, an air flow used to discharge heat from the at least one component can flow in one of the flow channels. The other flow channel can comprise a supply line, for example, through which the cleaning fluid can be supplied to the at least one cleaning nozzle, in particular from a cleaning fluid tank. The two flow channels are preferably disposed in such a manner that they are in heat-transferring connection with each other so that the waste heat absorbed by the air flow can be transferred to the cleaning fluid via an in particular heat-conducting separating wall, for example. Other configurations of the heat exchanger are conceivable, as well, as long as the waste heat can be transferred from the at least one component to the cleaning fluid and/or the cleaning nozzle. For example, the heat exchanger can also be formed by a heat pipe through which the at least one component is connected to at least part of the cleaning feature. The waste heat can be transferred from the component, which serves as a heat source, to the cleaning feature, which serves as a heat sink, via the heat pipe.

In a preferred embodiment, the cleaning feature comprises at least one cleaning fluid channel configured to supply the cleaning fluid to the at least one cleaning nozzle. The cleaning fluid channel is coupled with the heat exchanger in a heat-transferring manner. Particularly preferably, the at least one cleaning fluid channel is part of the heat exchanger. For example, the heat exchanger can be a heat-conducting material block made of aluminum, for example within which an in particular meandering passage channel is formed, which at least partially defines the cleaning fluid channel. If the heat exchanger has two or more channels, one of the channels preferably forms the cleaning fluid channel at least in part.

In a preferred embodiment, the thermal management feature comprises a flow channel in which the heat exchanger is disposed or formed and which is configured to discharge the waste heat of the at least one component. In such a configuration, the heat exchanger has at least two channels, as described above. One of the channels forms the flow channel, through which an air flow for controlling the temperature of the at least one component can preferably flow. The air flow inside the flow channel can preferably be established by an in particular controllable fan. Particularly preferably, the thermal management feature comprises an air inlet for the air supply. Moreover, it is preferred for the thermal management feature to comprise an air outlet through which the air flow can exit the roof module after having discharged heat from the at least one component.

Particularly preferably, the thermal management feature is configured in such a manner that the temperature of the at least one component can be actively controlled only as needed and the thermal management feature can otherwise be functionally decoupled from a heat discharge from the at least one component. For example, such a functional decoupling can take place by turning the fan on and off, in particular in a controllable manner, and/or by opening and closing an air inlet, in particular in a controllable manner.

In a preferred embodiment, the heat exchanger is in preferably direct heat-conducting connection with a component housing of the at least one component or is in heat-conducting connection with the at least one component via a heat transfer element and/or a heat pipe. The heat exchanger is preferably configured to control the temperature of the at least one component by transferring the waste heat of the at least one component to the cleaning fluid. Particularly preferably, the heat exchanger is an in particular integral part of the component housing. Such a configuration is advantageous since the waste heat of the component can be discharged almost directly at the heat source (which is located inside the housing). So the heat exchanger can preferably be connected to the at least one component in a heat-conducting manner without any other intermediate components (i.e., directly). In order to increase a design flexibility in particular in choosing the position and the arrangement of the at least one component relative to the heat exchanger and/or the cleaning feature, it is preferred for the at least one component and the heat exchanger to be thermally coupled via at least one intermediate component, such as a heat pipe or a heat transfer element. By using a heat pipe, a particularly high design flexibility can be achieved. In the simplest case, the heat conduction element can be a mounting plate and/or a part of a vehicle body via which the waste heat can be transferred to the heat exchanger.

In a preferred embodiment, the at least one component is coupled to the at least one cleaning nozzle in a heat-conducting manner, in particular via a heat pipe and/or a heat transfer element, so that the waste heat of the at least one component can be transferred to the at least one cleaning nozzle via the heat pipe and/or the heat transfer element in order to heat the at least one cleaning nozzle. So in case it is alternatively or additionally preferred for the at least one cleaning nozzle to be heated, it can be connected to the at least one component in a heat-conducting manner in a constructively simple manner according to the invention instead of being heated by an electrical heating device. Thus, the at least one cleaning nozzle can be effectively prevented from freezing according to the invention.

In a preferred embodiment, the thermal management feature comprises an evaluation and control feature configured to detect a temperature state of the at least one component, preferably continuously, more preferably in real time, and determine therefrom the amount of waste heat to be discharged from the at least one component. For this purpose, the evaluation and control feature particularly preferably compares a temperature of the component and/or a component periphery, which is in particular measured by a temperature sensor, to a predetermined limit temperature and/or a predetermined limit temperature interval. The evaluation and control feature is configured to control the temperature of the at least one component by discharging heat to the cleaning fluid up to a predetermined amount of waste heat and to control the temperature of the at least one component by switching on an active temperature control by the thermal management feature starting from the predetermined amount of waste heat. For example, if a predetermined limit temperature or an upper limit of the limit temperature interval of the component and/or in the component periphery is exceeded, the evaluation and control feature switches on the thermal management feature and/or at least individual functions of the thermal management feature, preferably in steps, in order to enable an effective cooling of the component. This can take place by switching a fan on and off and/or by controlling a fan power of the fan in steps and/or by activating a spray cooling, for example.

In a preferred embodiment, the at least one electrical, electronic and/or electromagnetic component comprises an antenna and/or a measuring sensor and/or a communication feature and/or an evaluation and/or control feature, in particular a controlling device, and/or a light feature and/or an environment sensor, in particular a lidar sensor and/or a radar sensor and/or a camera sensor and/or a multi-camera sensor and/or an ultrasonic sensor. Of course, the component can also comprise more than one of each of the mentioned components. The antenna can be an electrical or magnetic antenna. The measuring sensor can be a temperature sensor, a humidity sensor, a GPS sensor, an acceleration sensor and/or a similar measuring sensor, for example. The communication feature can be a WLAN interface, an LTE interface or another near-, medium- or long-range communication interface. The communication feature allows the motor vehicle to communicate with a vehicle environment and in particular send and/or receive data. The light feature can comprise one or more than one light. The lights are in particular configured to indicate a (semi-)autonomous driving mode and/or different driving mode situations of the motor vehicle. The environment sensor according to the invention can basically be configured in various ways and can comprise a lidar sensor, a radar sensor, an optical sensor, such as a camera or a multi-camera, an ultrasonic sensor and/or the like. Lidar sensors, for example, operate in a wavelength range of 905 nm or approximately 1550 nm. A material in a see-through area of the environment sensor is preferably transparent to a wavelength range used by the environment sensor and is selected as a function of the wavelength(s) used by the environment sensor. Of course, merely a signal detection unit, such as an optical sensor and/or a fotochip, may be disposed on the vehicle body. Evaluation electronics, in particular referred to as a camera control unit (CCU), which is configured to evaluate the signals detected by the optical sensor, can be disposed separately therefrom in another area of the motor vehicle, for example. The evaluation and/or control feature can be a controlling device, for example, which comprises one or more than one processor and/or a non-volatile memory and/or a temporary memory (RAM) and which is preferably configured to prompt a control of at least one operating function of another electrical and/or electronic and/or electromagnetic component on the basis of a control protocol and/or evaluate at least one input parameter transmitted to the evaluation and/or control feature on the basis of an evaluation algorithm.

In a preferred embodiment, the thermal management feature comprises at least one flow channel and/or at least one air inlet and/or at least one air outlet and/or at least one fan and/or at least one cooling element and/or at least one heat exchanger and/or at least one heat pump and/or at least one heat pipe. For example, the at least one component can be connected to the heat exchanger in a heat-conducting, in particular heat-transferring, manner via a heat conduction element and/or a heat pipe. Particularly preferably, the thermal management feature comprises at least one flow channel, which preferably forms at least part of the heat exchanger. At least one cooling element, in particular with a plurality of cooling ribs, can be provided in the flow channel, an air flow flowing across the cooling element. The cooling element allows the waste heat emitted by the component to be effectively transferred to the heat exchanger. The thermal management feature preferably forms a wet area inside at least part of the flow guide element, through which humid air can flow without leading to corrosion issues. This is advantageous since humid air has a higher heat storage capacity than dehumidified air. It is also advantageous for the thermal management feature to comprise a heating element by means of which air entering the at least one flow channel can be heated in order to thus heat the at least one component to a predetermined operating temperature, for example. It can also be advantageous for the at least one flow channel to be connected to other flow channels in the motor vehicle in such a manner that an air flow can flow through all flow channels, in particular without interruption.

In a preferred embodiment, the thermal management feature is configured to preferably discharge waste heat from each of multiple electrical and/or electronic and/or electromagnetic components, in particular through the heat exchanger and/or at least one heat pipe. For example, the thermal management feature can comprise one or more than one heat pipe by means of which the waste heat of each of the components can be collected and supplied to the heat exchanger in collected form. This is advantageous since it allows waste heat of the electrical and/or electronic and/or electromagnetic components to be transferred to the heat exchanger in an accumulated and centralized manner. Since the cleaning feature, in particular at least one supply line and/or the cleaning nozzle, is connected to the heat exchanger in a heat-transferring manner, a greater amount of waste heat, namely the waste heat of multiple components, can be used for heating the cleaning fluid. This allows the cleaning fluid to be heated to a higher temperature. Particularly preferably, the thermal management feature comprises at least one temperature sensor, which preferably detects a temperature of the at least one component or in a periphery of the at least one component at predetermined time intervals or in real time and transmits it to the evaluation and control feature of the thermal management feature. Based on this temperature and/or the amount of waste heat to be discharged as determined therefrom, the evaluation and control feature can determine whether a heat discharge to the cleaning fluid is sufficient for effectively cooling the at least one component or whether additional cooling by the thermal management feature, e.g., by activating a fan, may be required in order to keep the at least one component at a predetermined operating temperature or so as to not exceed the latter. This significantly increases the fail safety of the at least one component.

In a preferred embodiment, the roof module is disposed on a vehicle body of a motor vehicle as a structural unit. In this case, the roof module can preferably be disposed on the vehicle body by being connected to the at least one longitudinal rail or longitudinal beam of a vehicle roof frame, which is part of the vehicle body, preferably via a glued connection, a screwed connection and/or a welded connection. The roof module can preferably form a structural unit in which features for autonomous or semi-autonomous driving assisted by driver assistance systems are integrated and which can be placed and/or arranged on a vehicle carcass as a unit by a vehicle manufacturer. Furthermore, in one configuration of the roof panel element, the roof module according to the invention can form a purely fixed roof or a roof panel element including a roof opening system. Furthermore, the roof module according to the invention can be configured for use on a passenger car or on a utility vehicle.

Of course, the embodiments and the illustrative examples mentioned above and yet to be discussed below can be realized not only individually but also in any combination with each other without departing from the scope of the present invention. Moreover, any and all embodiments and illustrative examples of the roof module also relate equivalently to a motor vehicle having such a roof module.

### BRIEF DESCRIPTIONS OF THE DRAWINGS

Embodiments of the invention are schematically illustrated in the drawings and will be discussed as examples below.

FIG. 1 is a perspective view of a motor vehicle having a roof module according to the invention;

FIG. 2 is a first exemplary embodiment of the roof module according to the invention;

FIG. 3 is a second exemplary embodiment of the roof module according to the invention;

FIG. 4 is a third exemplary embodiment of the roof module according to the invention; and

FIG. 5 is a fourth exemplary embodiment of the roof module according to the invention.

### DETAILED DESCRIPTION

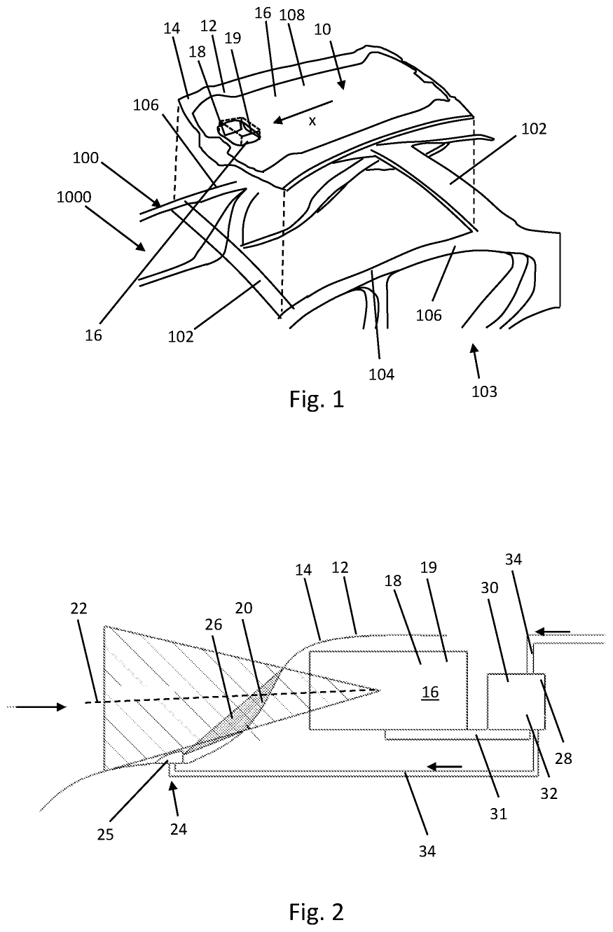

FIG. 1 shows a motor vehicle 1000 (not shown in full) having a vehicle roof 100. According to the invention, vehicle roof 100 is a roof module 10, in particular a roof sensor module. Roof module 10 is inserted into a roof frame 104 of motor vehicle 1000 or placed on top of the at least two transverse rails 102 (only one visible) and the at least two longitudinal rails 106, which form roof frame 104, as a structural unit. The roof module 10 in the shown exemplary embodiment has a panoramic roof 108.

Roof module 10 comprises a panel component 12 for forming a roof skin 14 of vehicle roof 100. In a front area of vehicle roof 100 or roof module 10 (with respect to a longitudinal vehicle direction x), an electrical and/or electronic and/or electromagnetic component 16 is disposed symmetrically with respect to longitudinal vehicle axis x. In the case at hand, the at least one component 16 is an environment sensor 18, which is disposed in a component housing 19. In the case at hand, environment sensor 18 is a lidar sensor as an example. However, other sensor types, such as (multi-directional) cameras, which are used in (semi-)autonomous driving, can be employed, as well.

Component housing 19 forms a dry area, in which environment sensor 18 is disposed in a moisture-proof manner.

In the case at hand, environment sensor 18 is disposed directly behind a front transverse rail 102, which defines a roof header of the vehicle. According to FIG. 1, environment sensor 18 is disposed on a frame structure of roof module 10 (or mounted thereon) in such a manner in an opening (not shown) of roof skin 14 of roof module 10 that it can be adjusted between a retracted position and a deployed position, i.e., it is retractable and deployable. In alternative embodiments, see FIGS. 2 to 5, for example, environment sensor 18 or the at least one component 16 is comprised on or in roof module 10 in a fixed manner. In this case, the at least one component 16 is preferably covered by panel component 12 or roof skin 14. Depending on the placement or the adjustability of the at least one component 16, component housing 19 and/or panel component 12 comprises a see-through area 20. See-through area 20 is preferably made of an in particular shatter-proof plastic or glass or another (partially) transparent material. Environment sensor 18 is aligned with an optical axis 22 (see FIG. 2) parallel to longitudinal vehicle direction x as an example.

Furthermore, roof module 10 comprises at least one cleaning feature 24 having at least one cleaning nozzle 25. Cleaning nozzle 25 is configured to eject a cleaning fluid in order to clean see-through area 20 with it. The cleaning fluid can be a liquid, such as water and/or soapy water, or an in particular pressurized gas. When the cleaning fluid leaves cleaning nozzles 25, a fluid cone 26 is produced, which strikes see-through area 20 and cleans it (see FIGS. 2 to 5). In the event that preferably multiple cleaning nozzles 25 are employed, fluid cones 26 can preferably overlap at least in part in an area of overlap (not shown) of see-through area 20 to thus increase the cleaning effect in this area of overlap.

According to the invention, the cleaning effect is further increased by the fact that the cleaning fluid is heated before leaving the at least one cleaning nozzle 25 and/or the at least one cleaning nozzle 25 itself is heated. In the case at hand, this is achieved by the fact that the at least one component 16 is in heat-transferring connection with cleaning feature 24 in such a manner that waste heat of the at least one component 16 is transferred to the cleaning fluid and/or the at least one cleaning nozzle 25. There is a plurality of options with regard to the heat transfer from the at least one component 16 to the cleaning fluid and/or cleaning nozzle 25, four different examples of which are shown in FIGS. 2 to 5.

For discharging heat from the at least one component 16, roof module 10 comprises a thermal management feature 28, which is configured to control the temperature of, in particular cool, the at least one component 16. Thermal management feature 28 comprises a heat exchanger 30, which is in heat-conducting connection with the at least one component 16 and which is configured to transfer the introduced waste heat of the at least one component 16 to the cleaning fluid. Heat exchanger 30 can be connected to the at least one component 16 in a heat-conducting manner directly or via a heat conduction element 31 (see FIG. 2) or a heat pipe 33 (not shown).

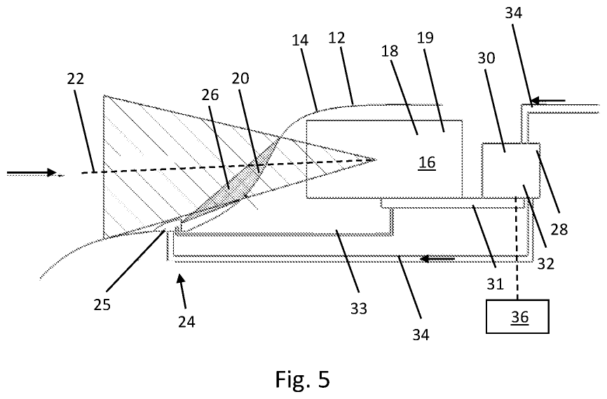

Thermal management feature 28 preferably comprises a flow channel 32, in which heat exchanger 30 is formed or disposed (see FIGS. 2 and 5). Preferably, a fan and/or other components of thermal management feature 28 can be disposed in flow channel 32.

The heat transfer within heat exchanger 30 to cleaning fluid preferably takes place since cleaning feature 24 comprises at least one cleaning fluid channel 34, which is configured to supply the cleaning fluid to the least one cleaning nozzle 25. Cleaning fluid channel 34 is preferably coupled to heat exchanger 30 in a heat-transferring manner or is part of heat exchanger 30. The cleaning fluid preferably flows through cleaning fluid channel 34 on its way to the at least one cleaning nozzle 25 (see FIGS. 2, 3 and 5). In the process, the cleaning fluid preferably passes through heat exchanger 30; cleaning fluid channel 34 can preferably be a channel formed at least partially in heat exchanger 30. Before entering heat exchanger 30, the cleaning fluid is preferably not yet heated or has been pre-heated in other embodiments. On its way through heat exchanger 30, the cleaning fluid absorbs at least part of the waste heat emitted to heat exchanger 30 with the result that the cleaning fluid is heated. The heated cleaning fluid leaves heat exchanger 30 on its way to the at least one cleaning nozzle 25 and is supplied to the latter in this heated state. Particularly preferably, the at least one cleaning fluid channel 34 is formed outside of heat exchanger 30 and is thermally insulated so as to prevent a heat loss of the cleaning fluid.

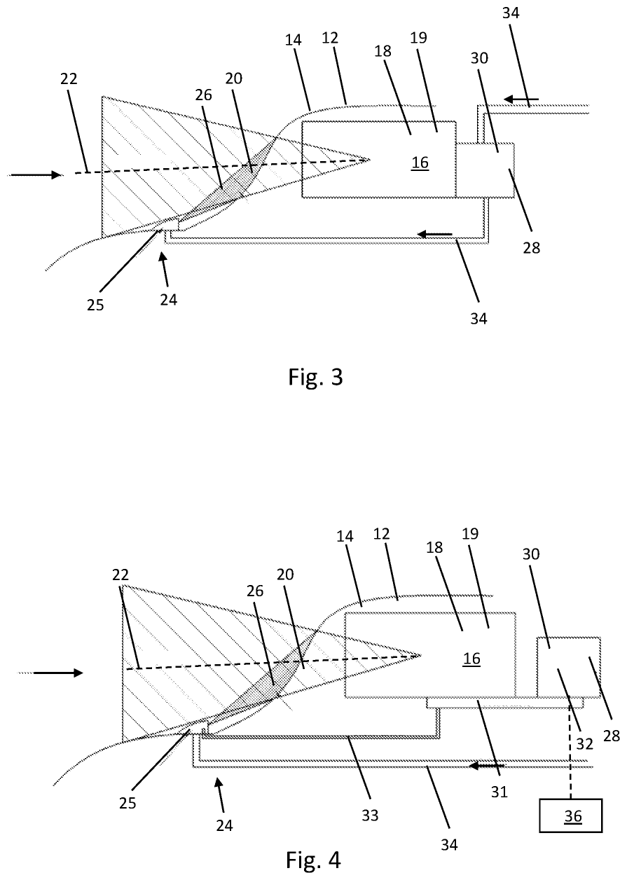

According to FIG. 3, heat exchanger 30 can also be disposed directly on component housing 19 or be integrally formed by the latter. In this case, no heat conduction element 31 is needed between component 16 and heat exchanger 30.

Alternatively or additionally to heating the cleaning fluid, the waste heat of the at least one component 16 can heat the at least one cleaning nozzle 25, in particular a nozzle body. To this end, cleaning nozzle 25 is preferably thermally coupled with the at least one component 16 via a heat pipe 33 so that the waste heat can be transferred from component 16 to cleaning nozzle 25 via heat pipe 33 (see FIGS. 4 and 5). According to FIG. 4, only cleaning nozzle 25 is heated by the waste heat of component 16. According to FIG. 5, both the cleaning fluid and cleaning nozzle 25 are heated. So, according to FIG. 5, cleaning fluid channel 34 is routed through heat exchanger 30 with the result that the cleaning fluid is heated. Moreover, the at least one component 16 is connected to cleaning nozzle 25 in a heat-conducting manner via heat pipe 33. So, according to FIG. 5, cleaning nozzle 25 can be preheated so that the heated cleaning fluid is not cooled by the nozzle body when leaving cleaning nozzle 25. In this way, the most efficient cleaning and/or deicing of see-through area 20 can be provided.

Particularly preferably, thermal management feature 28 comprises an evaluation and control feature 36 (see FIGS. 4 and 5), which is configured to preferably continuously detect a temperature state of the at least one component 16 and determine therefrom the amount of waste heat to be discharged from the at least one component 16, to control the temperature of the at least one component 16 by discharging heat to the cleaning fluid up to a predetermined amount of waste heat and to control the temperature of the at least one component 16 by switching on an in particular active cooling by thermal management feature 28 starting from the predetermined amount of waste heat.

1. A roof module for forming a vehicle roof on a motor vehicle, the roof module comprising:
a panel component, which at least partially forms a roof skin of the vehicle roof,
the roof skin serving as an outer sealing surface of the roof module,
at least one electrical and/or electronic and/or electromagnetic component, and/or a light feature, configured to send and/or receive electromagnetic signals through a see-through area, and
at least one cleaning feature having at least one cleaning nozzle configured to spray a cleaning fluid by which the see-through area is cleanable,
wherein the at least one component is in heat-transferring connection with the cleaning feature in such a manner that waste heat of the at least one component can be transferred to the cleaning fluid and/or the at least one cleaning nozzle.

2. The roof module according to claim 1, wherein the roof module comprises a thermal management feature configured to control the temperature of the at least one component and having a heat exchanger which is in heat-conducting connection with the at least one component and which is configured to transfer the introduced waste heat of the at least one component to the cleaning fluid.

3. The roof module according to claim 2, wherein the cleaning feature comprises at least one cleaning fluid channel configured to supply the cleaning fluid to the at least one cleaning nozzle and coupled with the heat exchanger in a heat-transferring manner.

4. The roof module according to claim 2, wherein the thermal management feature comprises a flow channel in which the heat exchanger is disposed or formed and which is configured to discharge the waste heat of the at least one component.

5. The roof module according to claim 2, wherein the heat exchanger is in direct heat-conducting connection with a component housing of the at least one component or is in heat-conducting connection with the at least one component via a heat transfer element and/or a heat pipe and is configured to control the temperature of the at least one component by transferring the waste heat of the at least one component to the cleaning fluid.

6. The roof module according to claim 1, wherein the at least one component is coupled with the at least one cleaning nozzle in a heat-conducting manner via a heat pipe and/or a heat transfer element, so that the waste heat of the at least one component is transferrable to the at least one cleaning nozzle via the heat pipe and/or the heat transfer element to heat the at least one cleaning nozzle.

7. The roof module according to claim 2, wherein the thermal management feature comprises an evaluation and control feature configured to continuously detect a temperature state of the at least one component and to determine therefrom the amount of waste heat to be discharged from the at least one component, control the temperature of the at least one component by discharging heat to the cleaning fluid up to a predetermined amount of waste heat and to control the temperature of the at least one component by switching on an active temperature control by the thermal management feature starting from the predetermined amount of waste heat.

8. The roof module according to claim 1, wherein the at least one electrical, electronic and/or electromagnetic component comprises an antenna and/or a measuring sensor and/or a communication feature and/or an evaluation and/or control feature and/or the light feature and/or the environment sensor, including at least one of a lidar sensor, radar sensor, camera sensor, multi-camera sensor, and ultrasonic senor.

9. The roof module according to claim 1, wherein the roof module is disposed on a vehicle body as a structural unit.

10. A motor vehicle comprising a roof module according to claim 1.

11. The roof module according to claim 1, wherein the at least one electrical and/or electronic and/or electromagnetic component is an environment sensor.

12. The roof module according to claim 2, wherein the thermal management feature is configured to cool the at least one component.
